(19) United States
(12) Patent Application Publication
(10) Pub. No.: US 2020/0160736 A1
(43) Pub. Date: May 21, 2020

(54) DETERMINATION OF A PAVEMENT STATE FROM ON-BOARD MEASUREMENTS OF PAVEMENT CONTAMINATION, ASSOCIATED SYSTEM AND AIRCRAFT

(71) Applicant: Airbus Operations SAS, Toulouse (FR)

(72) Inventor: Fabien MOLL, Toulouse (FR)

(21) Appl. No.: 16/687,110

(22) Filed: Nov. 18, 2019

(30) Foreign Application Priority Data
Nov. 20, 2018 (FR) 1871611

(51) Int. Cl. G08G 5/00; G08G 5/06

(52) U.S. Cl. CPC G08G 5/0086; G08G 5/065; G08G 5/0091

(57) ABSTRACT

A method and a system for determining a pavement state are proposed. The method determines the pavement state from climatic data, i.e. data on the climate outside an aircraft operating on a pavement for aircraft, and pavement data, i.e. data relating to the pavement. The climatic data and the pavement data are acquired by sensors located on-board the aircraft. Because the pavement data, i.e. measurements of parameters of the pavement itself, are acquired by the aircraft itself, the system makes it possible to tell the difference between a plurality of pavement states in a plurality of pavement locations including zones upstream of the aircraft, whereas known solutions are limited to aircraft taxiing zones, generally braking zones.

### CROSS-REFERENCES TO RELATED APPLICATIONS

This application claims the benefit of the French patent application No. 1871611 filed on Nov. 20, 2018, the entire disclosures of which are incorporated herein by way of reference.

### FIELD OF THE INVENTION

The present invention relates to a system and method for determining a pavement state, and to an aircraft equipped with such a system.

### BACKGROUND OF THE INVENTION

Knowledge of the surface state of a pavement is important to increasing the safety of the operational phases of an aircraft on the pavement, such operational phases being takeoff, landing or simply taxiing. It may, for example be a question of a runway, of a taxiway or of an apron.

For example, this knowledge makes it possible to better predict the braking performance of the aircraft. It thus allows the distance required to stop the airplane during a landing to be better estimated with a view to improving safety, but also makes it possible to avoid overestimating the distance required to completely stop the airplane and therefore, in addition, to avoid penalizing operations involving the pavement and the airplane.

Good knowledge of the pavement state in particular allows the risk of accidents during landing to be decreased, and, in particular, the number of runway excursions due to a contaminated or wet runway to be decreased.

Although, historically, pavement state has been determined on the ground then transmitted by the control tower to approaching airplanes, devices have been developed for determining a pavement state from airplane measurements. This is the case of the publication FR2978736, in which a pavement state is obtained by comparing friction/adhesion and slip data with theoretical models.

This approach is however limited to the case of braking and does not allow the cause (type of contaminant) of this degraded friction to be characterized.

### SUMMARY OF THE INVENTION

In this context, the invention proposes a method comprising determining a pavement state from climactic data, i.e., data on the climate outside of an aircraft operating on a pavement for aircraft, and pavement data, i.e., data relating to the pavement, characterized in that the climatic data and the pavement data are acquired by sensors located on-board the aircraft. The acquisition takes place during the operational phase (typically takeoff, landing, taxiing) of the aircraft on the pavement.

The pavement data thus acquired by the aircraft during the operational phase allow a better knowledge of the pavement conditions (for example, a better map) to be obtained and therefore the pavement state to be better determined automatically. The operational phase of the aircraft (for example, braking) is improved thereby. Likewise, a better predictability of these operations is obtained, resulting in better aircraft-fleet management and punctuality.

Moreover, this enhanced knowledge, which may be relayed to ground crew, allows the number of visual pavement inspections, which have historically been necessary, to be decreased, and therefore the number of any cleaning operations to be decreased.

Correspondingly, the invention also relates to a system for determining a pavement state, comprising sensors located on-board an aircraft operating on a pavement for aircraft and a module for obtaining a state of the pavement from climatic data, i.e., data on the climate outside the aircraft, and pavement data, i.e., data relating to the pavement, these data being acquired by the sensors located on-board the aircraft.

The system has similar advantages to those of the above method.

Such a system may, in particular, serve in the context of a system for assisting with the piloting of aircraft, and in particular to brake the latter. Specifically, the determined pavement state may be used to control one or more braking devices (reverse thrust, wing flaps, wheel brakes, etc.) of the aircraft or even one or more navigation devices (to choose, for example, an exit taxiway). A method for assisting with piloting aircraft also results therefrom.

Another aspect of the invention relates to an aircraft comprising a system for determining a pavement state such as presented above.

In one embodiment, the pavement state is also determined from dynamic aircraft operating data acquired by sensors located on-board the aircraft. Such a runway state is consolidated and therefore more precise because it is based on the response of the aircraft when the latter is taxiing on the pavement the state of which is to be qualified. This pavement state is therefore valid for the taxiing zone of the aircraft.

This contrasts with an embodiment in which the pavement state is determined for a pavement segment upstream of the aircraft, i.e., a segment over which the aircraft has not yet traveled, but, for example, where the aircraft is headed. Thus, the pavement state is not determined from dynamic aircraft operating data acquired by sensors on-board the aircraft (because they are not available). An improved determination of the upstream pavement state advantageously allows commands (braking, choice of exit taxiway, etc.) to be dynamically adjusted during the operation on the pavement.

Preferably, the acquired data are correlated to a position of the aircraft on the pavement during their acquisition. This makes it possible to effectively correlate the various data with the zones of the pavement, for a better map of the pavement state.

In one embodiment, at least one probability of presence of a type of contaminant (corresponding to the nature of the contaminant alone or to its nature and its thickness) is obtained, for a location on the pavement, from the acquired pavement data,

and the probability of presence of the type of contaminant is adjusted depending on acquired climatic data and more particularly on probabilities of presence associated with respective types of pavement contaminants, the probabilities being obtained, for the location on the pavement, from acquired climatic data. This may be done for a plurality or even all of the types of contaminant envisioned. Thus, a final contaminant indication is obtained (for example corresponding to the highest finally adjusted probability) for the pavement location.

The contaminates may be any element deposited on the “original” pavement, such as for example rubber deposited during preceding landings, oil, rainwater forming a relatively uniform layer on the pavement, snow, ice, sand, etc.

The granularity in the detection of the contaminants via the climatic data may be less than that achieved via the pavement data. In this case, a given probability obtained from the climatic data may similarly modify the probabilities obtained from the pavement data for two nearby contaminants.

In one embodiment, the probability of presence of the type of contaminant is furthermore obtained from taxiing information relative to a braking or adhesion level of the aircraft, the information being obtained from dynamic aircraft operating data acquired by sensors located on-board the aircraft.

In particular, a plurality of elementary probabilities of presence of the type of contaminant may be obtained, using a plurality of respective obtaining methods, from acquired pavement data, and an intermediate probability of presence of the type of contaminant may be obtained via a weighted combination of the elementary probabilities (for example a weighted sum).

Likewise, a plurality of elementary probabilities relative to a braking or adhesion level of the aircraft may be obtained, using a plurality of respective obtaining methods, from the acquired dynamic data, and an intermediate probability relative to a braking or adhesion level may be obtained via a weighted combination (for example a sum) of the elementary probabilities relative to a braking or adhesion level. The braking or adhesion level is highly correlated to pavement contaminants Thus, in one configuration, the probability of presence of the type of contaminant may depend on (for example be an average of) the intermediate probability of presence of the type of contaminant and the intermediate probability of the adhesion level correlated to the type of contaminant.

Various processing operations are thus carried out on each of the types of acquired data in order to obtain indications that are finally correlated (or merged) to obtain the final indication directly related to a pavement state for the location in question.

The weighting weights in the weighted combination are dependent on an operational phase of the aircraft (takeoff, approach, landing, braking, taxiing at high speed or taxiing at low speed, cornering, etc.). The phase may for example be detected using the speed of the aircraft: the weights may therefore vary depending on the speed of the aircraft.

Probabilities of presence of a type of contaminant may be obtained for two or more locations in a given width of pavement. This is made possible by acquiring pavement data directly with the aircraft. For example, cameras allow the width of the pavement to be scanned and thus various contaminants on the same width of pavement to be detected.

In one embodiment, an upstream pavement state is determined, from acquired climatic data and acquired pavement data, for a location that precedes the aircraft on the pavement.

Optionally, the upstream pavement state is compared to a reference pavement state for the location (for example a SNOWTAM notice received from the control tower). This allows an aircraft alert or control operation (for example modification of the braking) to be triggered when the predictive pavement state is degraded with respect to the reference pavement state.

Such an upstream pavement state may also be compared to a pavement state determined from climatic, dynamic and pavement data acquired for the same location. This, in particular, allows, depending on the noted differences, the logic allowing the upstream pavement state to be determined to be updated. Specifically, the pavement state finally encountered (deduced using the dynamic data acquired when the aircraft passes to the location) may be different from that determined upstream (at distance). The correction made may assist in improving the upstream determining scheme. For example, if the latter is a neural network, the upstream pavement state and that finally encountered are used in a learning process (update, self-learning) of the neural network.

In one embodiment, the pavement data are acquired by at least one among a camera and a laser sensor that are located on-board the aircraft.

In one embodiment, the determined pavement state is furthermore dependent on airport data delivered by a ground station.

### BRIEF DESCRIPTION OF THE DRAWINGS

Other particularities and advantages of the invention will become more clearly apparent from the following description, which is illustrated by the appended drawings.

FIG. 1 shows a general view of an aircraft for implementing the present invention;

FIG. 2 illustrates the operation of an on-board sensor of laser-scanner type;

FIG. 3 illustrates the determination of a pavement state according to embodiments of the invention;

FIG. 3a illustrates a weighted combination, weighted depending on the operational phases of the airplane, of elementary probabilities, for the sake of determining intermediate probabilities according to one embodiment of the invention;

FIG. 3b illustrate steps of the method thus implemented;

FIG. 4 schematically illustrates processing, by a ground station, of pavement states returned by a plurality of airplanes for the same pavement;

FIG. 5 schematically illustrates the determination of a pavement state of various times for a given pavement zone; and

FIG. 6 illustrates a use of the pavement state to know a potential available adhesion.

### DETAILED DESCRIPTION OF THE PREFERRED EMBODIMENTS

A method and system for determining a pavement state are proposed. The method determines the pavement state from climatic data, i.e., data on the climate outside an aircraft operating on a pavement for aircraft, and pavement data, i.e., data relative to the pavement. The climatic data and the pavement data are acquired by sensors located on-board the aircraft.

By virtue of the acquisition of pavement data by the aircraft itself, i.e., measurements of parameters of the pavement itself, the system automatically makes it possible to tell the difference between a plurality of pavement states in a plurality of pavement locations including zones upstream of the aircraft, whereas known solutions are limited to aircraft taxiing zones (generally braking zones).

The method may also be based on determination of dynamic aircraft operating data, themselves acquired by sensors located on-board the aircraft.

A pavement state is expressed using a predefined nomenclature, for example DRY (for a dry pavement, i.e., one without contaminant), or WET (for a wet pavement), WATER (for water), FROST (for frost), SLUSH (for melted snow), COMPACTED SNOW (for compacted snow), WET SNOW (for wet snow), DRY SNOW (for dry snow), ICE (for ice), WET ICE (for wet ice), WATER ON COMPACTED SNOW (for water on compacted snow) and SNOW OVER ICE (for snow above ice). The number of possible pavement states may be reduced by taking into account a height of the contaminant (water, snow, etc.) for example ¼″ (6.3 mm), ½″ (12.7 mm), etc.

Various types of pavement exist, including, in particular, runways and taxiways.

The pavement-state information is used by crew or by on-board systems to adjust the commands of the aircraft, for example (anti-skid) control laws, a path, a braking setpoint, or even an airplane objective (typically a target taxiway and the speed of entry onto this taxiway).

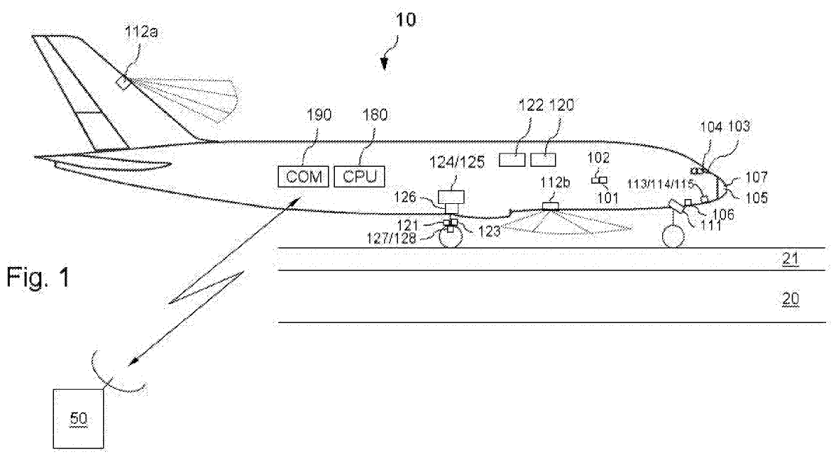

FIG. 1 illustrates an airplane 10 on a pavement 20, the airplane comprising a set of sensors 101 to 128, a processing unit 180 and a communication interface 190.

The communication interface 190 makes it possible to communicate with a ground station 50, which relays the information on the ground to a processing center. This processing center may either be located in the airport in which the pavement 20 is found or be remote.

The communication interface 190, for example, allows the airplane to collect information such as metrological data (or MET data) valid for the time at which the airplane is operating on the pavement, notices on the pavement conditions (NOTAM or SNOWTAM notices), data emitted by the processing center, originating from data of preceding flights, airport data (description of the pavements, for example, map of the airport, lengths and widths of the pavements, inclinations, orientations and GPS positions thereof, position of the runways/taxiways, etc.). These data may be transmitted in the form of D-ATIS messages (D-ATIS standing for datalink-automatic terminal information service). The airport data may also be accessible via a database located on-board the airplane.

The communication interface 190 also allows the airplane to send, to the ground, either measurements carried out by on-board sensors, or pavement states determined at one or more locations on the pavement (for example, in the form of a new NOTAM or SNOWTAM notice), or even intermediate data obtained during the determination of the pavement states.

The processing unit 180 comprises means (software codes, for example) for implementing the invention, and, in particular, for determining a state of the pavement 20, comprising qualifying the one or more contaminants 21 covering the pavement 20 in various locations, and their thicknesses where appropriate.

In one variant, the processing operations are carried out by the ground station 50, the aircraft merely transmitting to the latter, via the communication interface 190, the measurements acquired by the on-board sensors.

The sensors 101 to 128 may measure physical quantities or collect avionic parameters. As will be described below, the measurements of the sensors are used to generate, mainly, probabilities of presence of certain types of precipitation or of certain types of contaminants, or any other information that is directly related thereto (for example, a coefficient of adhesion). Preferably, these probabilities or related information are associated with locations on the pavement.

Certain sensors are sensors of environmental data such as climatic data, i.e., data on the climate outside of the aircraft, and pavement data, i.e., data relative to the pavement.

In the example of the figure, the airplane comprises:
an outside temperature probe 101 mounted on the external surface of the fuselage. It in particular delivers a measurement of the outside temperature, which may be considered to be constant over the airport, thus limiting the number of acquisitions,
a humidity sensor 102 also mounted on the external surface of the fuselage, and which delivers a measurement of the outside humidity level. Once again, the measurement carried out may be valid for all the airport. A lookup table, optionally specific to the airport in question, may associate the detected humidity level with a probability of precipitation or of non-precipitation, or even with probabilities (in case of precipitation given the temperature measured by the probe 101) on the type of precipitation: dew, fog, mist, rain, snow, etc.,
a sensor 103 for sensing the operation of the windscreen wipers, indicating whether the latter are activated or not. The sensor may also determine the duration of activation and the wiping speed. The indication of operation of the windscreen wipers is associated (in a table in memory for example) with a probability of precipitation, which is generally high, and a probability of non-precipitation, which is generally low (predefined probabilities, for example). These probabilities may be dependent on the wiping speed and on the duration of activation: the higher the speed or the longer the duration, the higher the probability of precipitation. Likewise, the indication of non-operation of the windscreen wipers is associated with a probability of precipitation, which is generally low, and a probability of non-precipitation, which is rather high (predefined probabilities, for example).

In one embodiment, a probability of large thickness of contaminant may be adjusted dynamically depending on the duration of activation and/or the wiping speed. This probability increases with the length of time of activation of the windscreen wipers and their speed. This dynamic adjustment may be based on a lookup table in memory, itself potentially specific to the airport in question (for example depending on knowledge of whether the pavements retain water relatively well or not),
an optical, and typically laser, disdrometer 104 that delivers measurements of the rate of precipitation and of the nature of the hydrometeors (rain, mist, snow, hail, ice pellets). These measurements may be considered to be valid for all the airport, in order to limit the acquisition thereof. As for any sensor, there is an uncertainty in the determination of the nature of the hydrometeors, generally because the domains of detection associated with each type of hydrometeors are not perfectly partitioned. Thus, a confidence score is assigned to this determination, which may take the form of probabilities associated with each of the identifiable types of hydrometeor,
a lidar (light detection and ranging) 105, laser sensor that measures a rate of precipitation up to 10 m in front of the airplane,
a pyrometer 106 measuring at distance, by measurement of thermal (infrared) radiation, a surface temperature of the pavement 20 in a zone substantially under the nose of the airplane or just in front thereof. This measurement may be considered to be “global,” i.e., to be true for all the airport,
an airborne precipitation radar 107, typically a weather radar, that detects the presence of precipitations and their nature (rain, mist, snow, hail, ice pellets). Such an airborne radar has an antenna that is oriented downward and that is scanned diagonally in order to acquire a three-dimensional image of the precipitations, ideally over the width of the pavement and in a pavement segment level with the airplane and in front thereof. Characteristic measurements of the observed precipitation are obtained from the acquired images: the radar reflectivity (the “brightness” at the frequency), depolarization (caused by melting or irregularly shaped ice particles) and Doppler velocity (measurement of the movement of the precipitation upward or downward). These measurements are then used to, for example, deduce a rate of precipitation, the nature of the hydrometeors and the location of ice on the pavement width. Preferably, the pavement is divided into zones (for example, zones of 10 m length and dividing the width into 4 zones) and the information is processed per zone. Once again, a confidence score is assigned in the determination of the nature of the precipitations, which may take the form of probabilities associated with each of the identifiable types of contaminant.

These various sensors 101 to 107 measure environmental parameters, from which climatic data, i.e., data on the climate outside of the airplane, are deduced, for example, probabilities of presence of certain types of precipitation (or absence of precipitation) but also objective measurements such as an outside temperature, a humidity level, a precipitation rate. Each climatic data may be locally valid (level with the airplane or in an identified remote zone) or globally applicable, i.e., applicable to all the pavement/airport.

In the example of the figure, the airplane also comprises:
a laser scanner 111 configured to acquire a thickness of (liquid or solid) aqueous contaminant on the pavement.

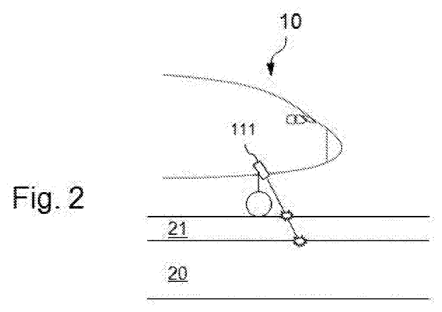

FIG. 2 illustrates the determination of this thickness using such a laser scanner 111. A laser ray is emitted. One portion thereof is reflected from the top surface of the contaminant 21. Another portion is reflected at the interface between the contaminant and the pavement 20. The scanner detects the reflected signals. The delay of the second reflected part with respect to the first portion allows a thickness of the contaminant 21 to be deduced.

Lateral scanning of the laser allows this acquisition to be performed over the pavement width or a segment thereof and therefore contaminant thicknesses to be obtained for a plurality of zones on the transverse axis of the pavement.

A longitudinal scan of the laser also allows this acquisition to be performed for a pavement segment upstream of the airplane and therefore contaminant thicknesses to also be obtained for a plurality of zones on the longitudinal axis of the pavement.

The measurements carried out are therefore assigned, where appropriate, to respective pavement zones (given the position of the aircraft and the position of the scanned zones relative to the airplane).

The laser scanner also makes it possible to tell the nature of the aqueous contaminant (if present): snow, ice, water . . . with a controlled uncertainty. For example, detection of the amount of signal reflected (albedo) by the first reflection from the contaminant 21 allows this nature to be identified: water reflects less (about 5%) than ice or compact snow (about 60%), which reflects less than fresh snow (about 80%). On account of the porosity between these detection domains, probabilities may be associated with each type of contaminant. For example, in case of detection of up to 70% signal reflection, a higher probability is assigned to a “fresh snow” contaminant then to an “ice” or “compact snow” contaminant, the probability of “water” being, for its part, very low,
external cameras 112, which may possibly be pre-existing. For example, illuminated taxiing cameras are already provided for assisting crew with night-time taxiing operations (taxi-aid camera).

The empennage taxi-aid camera 112a allows the main landing gear, the front of the airplane, the engines and the pavement in front of the airplane to be monitored. The underside taxi-aid camera 112b allows the front landing gear, the front of the airplane, the markings on the pavement and a width (for example, 9 m) on each side of the front landing gear to be seen.

Various image-recognition methods may be employed on the images acquired by these cameras to identify contaminants and the corresponding zone. For example, characteristic markers of contaminants may be computed from the acquired images (for example, white zone for snow, zone with rippled reflection for water or with set reflection for ice, black zone for dry tarmac). Probabilities assigned to the various components may thus reflect a degree of confidence in the detection of the contaminants.

The spray of water or snow by the landing gear may also be identified in order to detect the presence of a fluid contaminant and to estimate a thickness of contaminant in the zone of the airplane.

As a variant, a neural network may be used to make the detection of the contaminated zones more evolutionary.

Geometric considerations make it possible to link zones in the acquired images to zones on the pavement, taking into account the (GPS, for example) position of the airplane and of the parameters of the cameras (focal length, etc.). Thus, the probabilities of contaminants identified in the images are associated with pavement zones,
one (or more than one) spectroscopic camera(s) 113, based, for example, on hyperspectral imaging operating on a spectrum broader than the visible spectrum. The camera may be configured to operate in the infrared (IR) spectrum and thus be coupled to an IR emitter in order to ensure operability both during the day and at night. The camera here analyses the spectroscopic absorption of the observed coating, typically at two different IR frequencies (for example, 1320 nm and 1570 nm).

The IR emitter therefore emits two corresponding waves. The measurement of the absorbed intensity of the first wave with respect to that of the second wave follows different profiles depending on the nature of the coating. Reference profiles corresponding to the various types of coating/contaminant may be pre-recorded or modelled via a neural network, and be compared to the measurements carried out by the camera 113. A plurality of important coatings are thus distinguished: for example, dry asphalt in the absence of contaminant 21, wet asphalt, thick water or ice, snow, etc. Once again, an uncertainty remains in the distinction of the coating/contaminants since the correspondence between the measurements and the reference profiles is never perfect. Thus, probabilities are associated with each possible coating (and therefore associated potential contaminants),
one (or more than one) infrared (IR) camera(s) 114. Specifically, infrared cameras make it possible, using known techniques, to measure a surface temperature (surface of the contaminant 21 or pavement 20 here), a below-surface temperature (in case of contaminant) and a probability of presence of ice, snow or frost. Surface temperature affects the slipperiness of certain types of contaminants such as compacted snow or ice. The surface temperature may therefore increase the probability of evaluation in certain cases (a relatively high surface temperature in presence of compacted snow leads to a degraded adhesion/friction level in comparison with a lesser surface temperature),
one (or more than one) polarizing camera(s) 115 (i.e., cameras with a polarizing filter) which acquire the light reflected by the surface of the observed pavement. The polarization of the light varies depending on the nature of the observed surface, and in particular depending on whether or not water is present and, on its state, (liquid, ice, snow, crystals, etc.). Thus, the polarized image makes it possible to reveal the surface conditions of the pavement. Once again, probabilities are respectively associated with the possible surface conditions (and therefore the associated potential contaminants) in order to express uncertainties in the correspondence established between the measurements carried out with reference polarizations representative of the various conditions.

These various cameras 112, 113, 114, 115 are preferably oriented toward the pavement in front of the airplane in order to carry out the acquisitions, and therefore possibly a determination of a pavement state, prior to passage of the airplane. In particular, these cameras may operate while the airplane is in the approach phase, allowing a pavement state (other than that conventionally transmitted by the control tower) to be determined before touchdown on the pavement.

These various sensors deliver data relative to the pavement 20 and, more particularly, data relative to the pavement conditions (contamination conditions). It is a question of data measured directly on the pavement using on-board sensors.

Other sensors acquire dynamic data of the airplane, which data convey information on the behavior of the airplane given the state of the pavement:
the GPS and/or IRS and/or accelerometers 120 deliver measurements such as the (vertical, lateral, longitudinal) accelerations and the ground speed of the airplane,
one (or more than one) revolution counter(s) 121 positioned on all or some of the wheels of the airplane allow the linear speed of the wheels to be measured. Specifically, a difference between the linear speed of the wheels and the ground speed may indicate a possible degradation of the adhesion of the airplane to the ground. This information may be taken into account in anti-skid management,
a pitch and/or roll and/or yaw sensor 122 (measurements typically obtained by conventional airplane equipment),
one (or more than one) brake torque sensor(s) 123 the measurements of which may be correlated with pre-recorded models representing the degradation in braking capacity due to the loss of adhesion. The radius of the wheels and the vertical load on the landing gear being known, the measured brake torque allows the braking force to be known and therefore the friction level to be determined,
a braking instructions sensor 124, which typically senses the braking pressure and/or whether or not the anti-skid system is activated (typically Boolean logic). This information is, for example, obtained from the unit for controlling the braking and steering of the airplane. Specifically, this unit may deliver both the requested braking pressure setpoint and the pressure level actually applied to the brakes. In case of decreased adhesion, an excessively high applied braking pressure will lead the wheels to lock, which adversely affects the ability to brake. The anti-skid system then adjusts the applied pressure in order to avoid locking the wheels and seeks the optimal operating point. The difference between the braking pressure setpoint and the braking level applied to the brakes, as obtained from the anti-skid system, in particular, allows the adhesion level to be evaluated (good adhesion if the difference is very small, low adhesion otherwise).
a steering sensor 125 that, for example, measures a steering torque and/or a wheel steering angle. This information is, for example, obtained from the unit for controlling the braking and steering of the airplane,
a load sensor 126 capable of measuring the vertical load (or force) Fz on the airplane and/or the lateral load Fy. It may be a question of simple force gauges positioned on the landing gear. The measurement of these forces, in particular, allows a coefficient of adhesion to be computed. An example computation is described in patent application FR2978736,
one (or more than one) tire sensor(s) 127 mounted on the wheels in order to determine the pressure of the tires,
one (or more than one) optical tire sensor(s) 28 mounted on the landing gear, capable of measuring the deformations of the tires. Such sensors, for example, comprise a PSD (position-sensitive detector) chip mounted on the wheel rim and equipped with a convex lens for measuring the movement of an LED source adhesively bonded to the interior coating of the tire. A radio system transmits the measurements carried out. Models may be predefined that model, for example, aquaplaning or various adhesion levels, as a function of (lateral, longitudinal, vertical) deformations. An example of an optical tire sensor 128 is described in publication US 2017/137144.

Other dynamic data of the airplane may be acquired, including, for example, the weight of the airplane (delivered by the flight management system), engine parameters, wing-flap or baffle configurations (delivered by on-board computers), automatic braking information (whether the automatic braking is activated or not).

Of course, as a variant, only some of these sensors may be used. Furthermore, sensors other than those mentioned here may be envisioned in order to obtain all or some of the climatic data, pavement data and dynamic data.

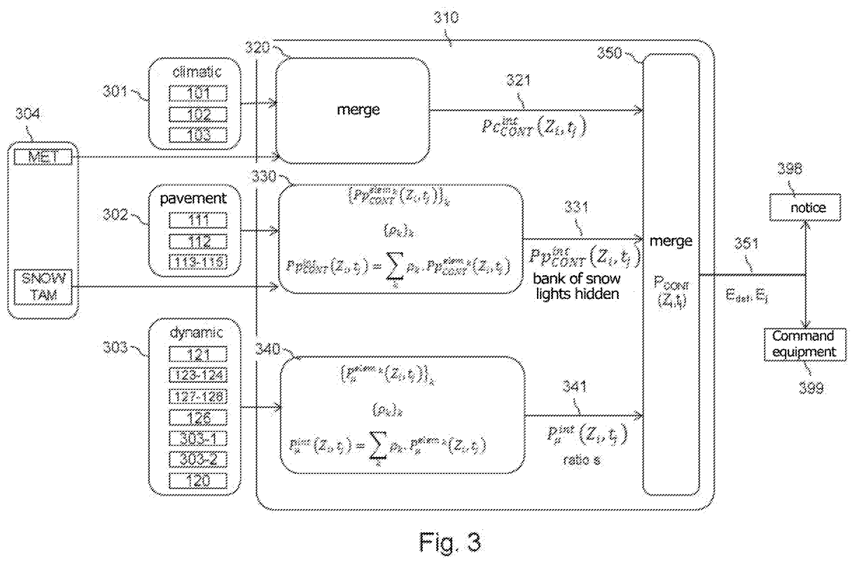

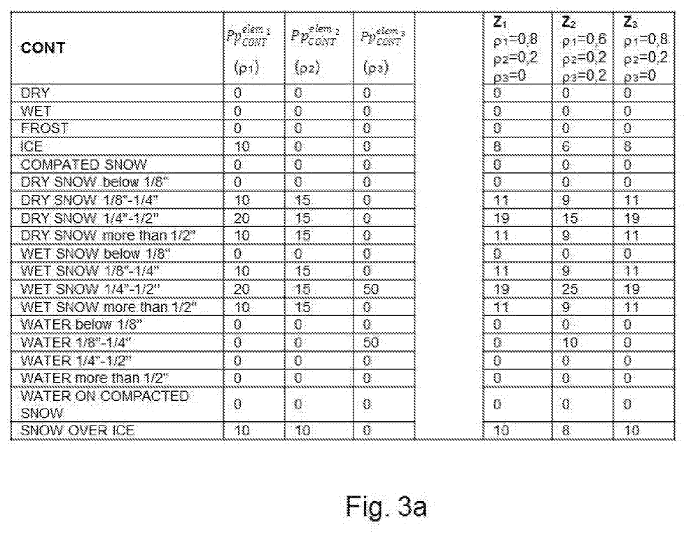

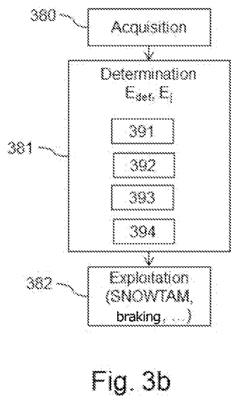

FIG. 3 illustrates an example of implementation of the invention in an aircraft, for example an airplane, in order to determine a pavement state.

In the figure, four data acquisition domains are shown:
a domain 301 relative to outside climatic data. They are acquired by on-board climatic-data sensors, for example the sensors 101 to 107 described above,
a domain 302 relative to the pavement data. They are acquired by on-board pavement-data sensors (of pavement contamination), for example sensors 111 to 115 described above,
a domain 303 relative to the dynamic data of the airplane, giving a behavior of the latter in light of the pavement state. They are acquired by on-board dynamic-data sensors, for example sensors 120 to 128 described above, and
an optional domain 304 relative to airport data, which are received from the ground station 50 via the communication interface 190.

A few nonlimiting examples of sensors are indicated in this figure. By way of illustration, the domain 303 also includes flight data that are deduced from other measurements carried out: for example, a braking distance 303-1 computed depending on a speed of the airplane, a braking force and/or a pavement state provided beforehand; also, a path 303-2 (for example designation of a predefined taxiway or a taxiway dependent on the above braking distance).

The processing block 310 allows a final pavement state Ei, Edef to be obtained from these data acquired by the sensors, and, in particular, from the outside climatic data 301 and the pavement data 302, i.e., the data relative to the pavement. The dynamic aircraft operating data 303 may also be used.

This final state or any similar datum may be used to update a pavement state notice, of NOTAM or SNOWTAM type, 398, or be used as input of a system 399 for assisting with piloting the airplane, for example a braking system of the airplane or a system for determining an exit taxiway.

The processing operations of the block 310 are preferably repeated at the successive acquisition times of the sensors, for example every 1/10 seconds.

These processing operations, at a given time tj, are preferably carried out for various locations on the pavement.

The locations may include a plurality of locations transverse to the airplane, i.e., a plurality of zones Zi over the width of the pavement on which the airplane is located. Thus, a plurality of respective pavement states Ej(Zi) may be determined at the time tj. By way of illustration, the width of the pavement may be divided into N equal zones or into zones of predefined width. A pavement state Edef(Zi) of a pavement zone Zi in which the airplane is located is preferably determined from the outside climatic data 301, the pavement data 302, i.e., the data relative to the pavement, and the dynamic aircraft operating data 303.

The locations may include a plurality of locations in front of the airplane, i.e., in pavement segments not yet crossed by the airplane. Zones may be defined that correspond to transverse and longitudinal segments of the pavement 20. A pavement state Ej(Zi) for these pavement zones Zi upstream of the airplane is determined from outside climatic data 301 and pavement data 302, i.e., data relative to the pavement. Specifically, no dynamic aircraft operating data 303 are available for these zones, since the airplane has not yet reached them. However, as described below, this upstream pavement state may be used to adjust the control of the airplane, then be compared to a local pavement state Edef(Zi) determined when the airplane actually reaches this zone. This comparison, in particular, allows the models used to predict the upstream pavement state to be adjusted.

The GPS position of the airplane and purely geometric considerations (for example, used to assign the zone scanned by laser or captured by a camera to a zone Zi of the pavement) allow pavement states determined, using the acquired data, to be associated with particular pavement zones.

A first stage of the block 310 comprises a processing operation specific to each domain 301-303. In the example, three blocks 320, 330, 340 are formed, the output data of which (including the probabilities of presence of contaminants or similar information) are processed by a final block 350 in order to obtain a pavement state for a zone Zi.

Thus, in the block 320, the outside climatic data acquired at the time tj for the zone Zi are merged to obtain the probabilities Pc_{CONT}^{int}(Zi, tj) 32 of presence relative to various possible contaminants CONT. Typically, a probability of presence of rain and a probability of presence of snow, and a probability of absence of precipitation are obtained. Optionally, a higher precipitation granularity is used: a probability of presence of ice, frost, hail, etc., and/or a probability of the contaminant thickness being large are/is obtained.

Various merging methods may be envisioned. They combine the measurements (or the information that is obtained therefrom) valid for a given location on the track, i.e., for a given one Zi of the zones into which the pavement 20 is divided. As indicated above, certain sensors deliver measurements that are valid for the entirety of the pavement (for example, thermometer and humidity sensor), i.e., for each pavement zone, other sensors are excessively local (pyrometer that measures under the nose of the airplane) and valid for one or a few zones, and lastly others observe a portion of the pavement in front of the airplane (for example the radar) and are valid for the corresponding zones.

For the zone Zi, a sensor allows probabilities for one, more than one or each type of precipitation to be obtained. For the same zone Zi, the average of the probabilities thus obtained for each type of precipitation and valid for this zone may be computed.

As a variant, the probability for each type of precipitation obtained from the measurements of a particular sensor (for example, the disdrometer 104) may be used as reference probability. This reference probability (for each type of precipitation) is then adjusted depending on the probabilities obtained from the measurements of other sensors. The number of adjustment points (%) may depend on the difference between the reference probability (optionally already adjusted) and the other probability to be taken into account. These adjustment points may be defined in a lookup table in memory. For example, in case of a difference of 5 to 10%, the adjustment may be of 1 point (or any other value) in the sense of the difference: if the reference probability of rain is 43% but the reference probability of rain issued from another sensor is 35%, then the reference probability may be adjusted to 42%.

These (original, average or adjusted reference) probabilities may also be adjusted depending on the temperature measured by the probe 101 and/or by the pyrometer 106: a temperature below +3° C. will improve the probability of snow to the detriment of the probability of rain; but also depending on the rates of precipitation measured by the one or more sensors 102, 103, 104, 105, 107: high rate or high probability of precipitation improves the probability of rain or snow to the detriment of a probability of absence of precipitation. A table in memory may specify the probability adjustments to be performed depending on the rates/probabilities of precipitation obtained from the measurements and also depending on the measured temperature (in particular, for temperatures in the vicinity of +3° C.).

The most probable type of contaminant may be associated with these probabilities of precipitation, for example using the measurements of the disdrometer 104 or of the radar 107, which are capable of distinguishing the nature of the hydrometeors.

Optionally, information (for example, a MET ratio) received from the ground station 50 may be used to refine these probabilities: increase the probabilities corresponding to the nature of the precipitation indicated by this information.

Thus, from the module 320, the probabilities of rain, of snow (inter alia) and of absence of precipitation are obtained for a location (the pavement zone in which the airplane is located) or even for a plurality of locations (zones over the width of the pavement on which the airplane is located, pavement zones in front of the airplane). It is therefore a question of probabilities of presence associated with respective types of pavement contaminant (including the absence of precipitation). These probabilities Pp_{CONT}^{int}(Zᵢ, tⱼ) are based on the measurements of a variable number of sensors (certain sensors being local, others global, i.e., true for all the airport, yet others observing one pavement segment in front of the airplane).

In the block 330, the pavement data acquired by the sensors 111 to 115 are also merged in order to obtain, for one or more zones Zi of the pavement, probabilities Pp_{CONT}^{int}(Zᵢ, tⱼ), 331, called “intermediate” probabilities, of presence of the contaminants, and a thickness of any contaminant (if not already an integral property of the type of contaminant in question). Complementary information on the environment of the pavement may also be identified via cameras: for example, presence of a bank of snow on the pavement edge (including its dimensions), absence of lights (hidden by the contaminant), etc.

Various methods (denoted “k”) allow elementary probabilities Pp_{CONT}^{elem}^{ₖ}(Zᵢ, tⱼ) of presence of a given type of contaminant CONT to be obtained for the zone Zi from pavement data acquired at the time tj, and this to be done for a plurality or even all of the possible types of contaminant. These probabilities are generally valid for a particular pavement zone. For example, as indicated above, the cameras 112 allow probabilities to be obtained for a plurality of types of contaminant for one or even more than one pavement zone(s) upstream of the airplane. The spectroscopic camera 113 also allows this. The polarizing camera 115 also allows this. The IR camera 114 may potentially allow this. Of course, combinations of measurements delivered by a plurality of sensors may be used to generate elementary probabilities.

These elementary probabilities Pp_{CONT}^{elem}^{ₖ}(Zᵢ, tⱼ) of presence of a given type of contaminant are then merged into an intermediate probability Pp_{CONT}^{int}(Zᵢ, tⱼ) of presence of the type of contaminant CONT for the zone Zi in question. Thus, for one or more of pavement zones, an intermediate property is obtained for each type of contaminant envisioned/monitored for.

For example, the average of the elementary probabilities obtained for a type of contaminant is used. As a variant, one elementary probability is used as reference, which is adjusted with the other elementary probabilities obtained for the same type of contaminant, as described above with respect to the block 320.

In one embodiment, the intermediate probability of presence of the type of contaminant is obtained via a weighted combination of the elementary probabilities of presence of the same type of contaminant:

Pp_{CONT}^{int}(Zᵢ,tⱼ)=Σₖρₖ·Pp_{CONT}^{elem}^{ₖ}(Zᵢ,tⱼ) [Formula 1]

where “k” designates the methods used.

Preferably, the weighting weights ρk (corresponding to each method for determining the elementary probabilities) in the weighted combination depend on an operational phase of the aircraft (takeoff, approach, landing, braking, taxiing at high speed or taxiing at low speed, etc.).

FIG. 3a illustrates an example of variable weighting depending on the operational phase of the airplane. In this example, three sensors CAPT1, CAPT2, CAPT3 are used.

For example, CAPT1 is a polarizing camera 115 that acquires the light reflected by the surface of the observed pavement. The polarization of the light varies depending on the nature of the observed surface, and, in particular, depending on whether or not water is present and, on its state, (liquid, ice, snow, crystals, etc.). CAPT2 is an infrared camera 114 that measures the surface temperature of the pavement. CAPT3 is a taxi-aid camera 112 with detection of the spray of water or of snow by the landing gear.

A method specific to each sensor allows elementary probabilities to be obtained for each method (and therefore each sensor) and each contaminant CONT:Pp_{CONT}^{elem}^{₁} for CAPT1, Pp_{CONT}^{elem}^{₂} for CAPT2 and Pp_{CONT}^{elem}^{₃} for CAPT3.

The weighted combination of these elementary probabilities (in percentage) used to obtain the intermediate probabilities (in percentage) depends on the operational phase of the airplane. In this example, three different operational times successively corresponding to three zones Z1, Z2, Z3 are considered. The zone Z1 corresponds to a zone from the runway threshold to touchdown of the landing gear, the zone Z2 corresponds to the touchdown of the landing gear to 30 knots and the zone Z3 corresponds to touchdown of the landing gear to parking.

With each method used (here each sensor CAPT1 to CAPT3) is associated a weighting coefficient ((ρ1 to ρ3, respectively) used for the weighted combination.

In the example, the weightings for the zones Z1 and Z3 are ρ1=0.8, ρ2=0.2, ρ3=0 whereas the weights for the zone Z2 are ρ1=0.6, ρ2=0.2, ρ3=0.2.

The obtained intermediate probabilities (columns Z1 to Z3) may therefore be different from one zone to the next because the operational phases are different.

The use of the cameras allows this estimation of intermediate probabilities to be carried out for various contaminants for a high number of pavement zones Zi, and, in particular, for zones in front of the airplane that have not yet been crossed thereby. Thus, the airplane may obtain a map at tj of intermediate probabilities of contaminants for pavement that has not yet been crossed thereby.

Optionally, information (for example, a NOTAM notice) received from the ground station 50 may be used to refine the intermediate probabilities associated with the various contaminants: increase of the intermediate probabilities corresponding to the nature of the contaminants indicated in this information for the zones in question.

In the block 340, the dynamic aircraft data acquired from sensors 120 to 128 at tj are also merged to obtain, for the pavement zone Zi in which the airplane is taxiing, probabilities P_{μ}^{int}(Zᵢ, tⱼ), 341, called “intermediate” probabilities, of aircraft adhesion level.

Complementary information, such as the slip ratio (or “ratio s”), may also be obtained from the computations carried out to determine the intermediate probabilities 341.

In one embodiment, a plurality of elementary probabilities P_{μ}^{elem}^{ₖ}(Zᵢ, tⱼ) relative to a braking or adhesion level of the aircraft may be obtained using a number of respective obtaining methods (k) from acquired dynamic data.

Specifically, various methods allowing an adhesion coefficient (also known as “mu” or μ) to be estimated from dynamic data acquired by the sensors 120 to 128 are known. By way of example:
a method based on an adhesion curve derived from deceleration measurements, allowing a ratio between a measured braking force Fb and a load FZ of the aircraft to be compared with a standard profile, in order to deduce therefrom an adhesion coefficient,
a method comparing a dynamically evaluated braking distance with a reference braking distance, the difference reflecting an adhesion coefficient,
a method considering a ratio between a braking pressure before activation of the anti-skid system and a braking pressure after activation of the anti-skid system. This ratio also reflects an adhesion coefficient (brought to light by the anti-skid system)
a method for analyzing the rise in braking pressure on activation of a braking setpoint. Specifically, the dynamic profile of the pressure rise is highly related to the ground adhesion of the aircraft,
a method for optically analyzing deformations of the tires, these deformations being correlated to adhesion levels using reference profiles,
a method for analyzing the speed differential of the wheels during cornering of the airplane (for example, on the taxiway). This differential divided by the curvature of the corner is representative of an adhesion level. Reference profiles associated with various adhesion levels may be used and compared to the computed differentials.

The adhesion levels obtained by these various methods may be reported using one and the same reference system, and, for example, the rating scale of 0 to 6 well known in the aeronautical field: 6 for DRY, 5 for GOOD, 4 for GOOD to MEDIUM, 3 for MEDIUM, 2 for MEDIUM to POOR, 1 for POOR, 0 for NIL.

These methods for determining an adhesion coefficient/level introduce uncertainty (imperfect correspondence with the models or reference profiles, for example). The correspondence with the ratings of 0 to 6 is also not perfect. Thus, probabilities are associated with the adhesion levels in order to reflect a confidence score. As a result, for example, each method k for example generates a so-called elementary probability P_{μ}^{elem}^{_{k(Z}}ᵢ, tⱼ) relative to each μ level (0 to 6) depending on the measurements on which it is based. P₃^{elem}^{₅} (Zᵢ, tⱼ) for example, corresponds to the probability of an adhesion level of 3 (MEDIUM) obtained using method 5 for the zone Zi from measurements acquired at tj.

The elementary adhesion-level probabilities may be computed globally for all the aircraft or wheel by wheel, in which case an average value may then be determined for the airplane. The elementary probabilities are valid for the pavement zone in which the aircraft is found during the acquisition of the measurements from which these probabilities are obtained.

In the block 340, these elementary probabilities relative to a given adhesion level (here one of the ratings 0 to 6) are combined, using a weighted combination, in order to obtain an intermediate probability 341 corresponding to this adhesion level:

P_{μ}^{int}(Zᵢ,tⱼ)=Σₖρₖ·P_{μ}^{elem}^{ₖ}(Zᵢ,tⱼ). [Formula 2]

As for the block 330, the weighting weights Pk in the weighted combination may depend on an operational phase of the aircraft (takeoff, approach, landing, braking, taxiing at high speed or at low speed, etc.).

By making the weights Pk in the blocks 330 and 340 vary it is possible to prioritize certain sensors or certain methods depending on the operational phase.

By way of illustration:

before braking, priority may be given to a detection by the cameras,

at the start of braking, priority may be given to an evaluation of the rise in braking pressure or to the estimation of the curve μ=f(s),

during braking, priority making given to a comparison of the distances, in case of insufficient braking, priority may once again be given to detection by the cameras,
during cornering, priority may be given to an estimation based on the speed of the wheels,
at low speed (for example under 30 knots), priority may be given to a detection by the cameras combined with an analysis of the braking pressure,

during a takeoff, priority may be given to a detection by the cameras.

The data 321, 331, 341 output from the blocks 320, 330, 340 are then processed by the final block 350 in order to generate a final pavement state.

As indicated above, a final pavement state Ej(Zi) for the time tj may be obtained for pavement segments upstream of the airplane. Since dynamic data have yet to be acquired for this pavement zone (since the airplane has not yet reached it), a probability P_{CONT}(Zᵢ, tⱼ) of presence of a type of contaminant CONT may correspond to the intermediate probability Pp_{CONT}^{int}(Zᵢ, tⱼ), 331, of presence of the type of contaminant, i.e., as computed by the block 330 for this zone. A probability is obtained for each type of contaminant.

This probability may be adjusted depending on the acquired climatic data valid for this zone Zi and, more particularly, depending on the probabilities Pc_{CONT}^{int}(Zᵢ, tⱼ), 321, of presence associated with respective types of pavement contaminants, the probabilities being obtained from the acquired climatic data.

For example, if the probabilities 321 indicate a high probability of precipitation of rain type for the zone in question, the intermediate probabilities 331 of WATER type may be increased (for example, those associated with the contaminants WET, WATER ⅛″, WATER ¼″ and WATER ½″) whereas the intermediate probabilities 331 relative to another contaminant may be decreased. The adjustment step size may be predefined (for example, N %).

Optionally, complementary climatic measurements may be taken into account. For example, a negative temperature should decrease the probabilities relative to contaminants of water type (WATER) to the benefit of snow and ice contaminants. For example, if the probabilities 321 indicate a high probability of precipitation of snow type for the zone in question and an outside temperature higher than or equal to 5° C., the intermediate probabilities 331 associated with the contaminants WET, WATER ⅛″, WATER ¼″ and WATER ½″ may be increased to the detriment of those associated with frozen contaminants (ICE, SNOW, etc.).

The final pavement state Ej(Zi) 351 output from the block 350 is that associated with the highest probability among the adjusted probabilities P_{CONT}(Zᵢ, tⱼ).

This final pavement state Ej(Zi) obtained for a pavement segment Zi upstream of the airplane 10 has the advantage of being able to improve the operational phases of the airplane. Specifically, this indication estimated in advance for example makes it possible:
to warn the pilot if the pavement conditions thus evaluated are degraded with respect to those indicated by the control tower,
to warn of any risk of departure from the pavement if the pavement conditions thus evaluated are incompatible with the current rate at which the airplane is moving,
adjust the control laws of the airplane (anti-skid, lateral control law, etc.) to the actual conditions of the pavement,
adapt the path of the airplane to the pavement conditions (adaptation of speed by acting on the brakes or the thrust inverters),
adjust the objectives of the airplane, for example by changing the taxiway used to exit from the runway.

The final upstream pavement state Ej(Zi) may also be transmitted to the ground station 50.

A final pavement state Edef(Zi) may also be obtained for the pavement segments Zi over which the airplane is taxiing. In this case, the dynamic data, and therefore the intermediate adhesion-level probabilities P_{μ}^{int}(Zᵢ, tⱼ), may be taken into account.

A probability P_{CONT}(Zᵢ, tⱼ) of presence of a type of contaminant may then correspond to the average of the intermediate probability Pp_{CONT}^{int}(Zᵢ, tⱼ) of presence of the type of contaminant and of the intermediate adhesion-level (μ) probability p_{μ}^{int}(Zᵢ, tⱼ) correlated with the type of contaminant CONT.

Specifically, the adhesion level μ (corresponding to the ratings from 0 to 6) is an indicator of the nature of the contaminant CONT 21 of the pavement 20. Tables used in the aeronautical field specify the correspondences.

An excellent adhesion (DRY, rating 6) generally indicates a DRY state (absence of contaminant).

A good adhesion (GOOD, rating 5) generally indicates a state or contaminant among: WET, FROST, and WATER, SLUSH, DRY SNOW or WET SNOW of a thickness below ⅛ of an inch.

An adhesion judged to be satisfactory (GOOD to MEDIUM, rating 4) generally indicates the state/contaminant COMPACTED SNOW in the presence of a temperature below −15° C.

An adhesion judged to be medium (MEDIUM, rating 3) generally indicates the state/contaminant WET (in case of a pavement known to get slippery), or one of the state/contaminants DRY and WET SNOW of a thickness larger than ⅛ inch for temperatures below −3° C., or the state/contaminant COMPACTED SNOW for temperatures comprised between −15° C. and −3° C.

An adhesion judged to be unsatisfactory (MEDIUM TO POOR, rating 2) generally indicates one of the states/contaminants WATER and SLUSH of a thickness larger than ⅛ inch or one of the states/contaminants DRY and WET SNOW of a thickness larger than ⅛ inch for temperatures above −3° C. or the state/contaminant COMPACTED SNOW for temperatures above −3° C.

An adhesion judged to be poor (POOR, rating 1) generally indicates the state/contaminant ICE for temperatures below −3° C.

An adhesion judged to be nil (NIL, rating 0) generally indicates one of the states/contaminants WET ICE, WATER ON COMPACTED SNOW, SNOW OVER ICE or the state/contaminant ICE for temperatures above −3° C.

Once the probability P_{CONT}(Zᵢ, tⱼ) of presence of a type of contaminant has been determined for a current zone (and for each type contaminant), this probability may be adjusted depending on the acquired climatic data as described above and, more particularly, depending on the probabilities Pc_{CONT}^{int}(Zᵢ, tⱼ) 321 of presence associated with the respective types of pavement contaminant obtained from the acquired climatic data.

Once again, the final pavement state 351 output from block 350 is that which, for example, has the highest probability among the adjusted probabilities.

As shown in the figure, the final pavement state 351 may be delivered in a notice 398 to the ground station 50 via the communication module 180 or be used dynamically to modify the behavior of the airplane, it, for example, being input into a braking system 399 in order to optimize braking and/or to activate an anti-skid system and/or to modify the exit taxiway (as already mentioned above) and/or to modify the speed that it is targeted to reach by the time the exit taxiway is taken.

FIG. 3b illustrates the steps of the method thus implemented.

In step 381, measurements are acquired by the sensors 101-128 within the domains 301, 302 and where appropriate 303.

In step 382, a pavement state Edef(Zi), Ej(Zi) is determined from these acquired measurements, using the block 310. A pavement state is obtained for one or more zones Zi and at one or more acquisition times tj.

This determination comprises determining 391, from the acquired climatic data and using the block 320, probabilities Pc_{CONT}^{int}(Zᵢ, tⱼ) 321 of presence associated with respective types of pavement contaminant CONT.

It also comprises determining 392, from the acquired pavement data and using the block 330, probabilities Pp_{CONT}^{int}(Zᵢ, tⱼ) 331, called “intermediate” probabilities, of presence of the contaminants CONT.

It optionally comprises determining 393, from the dynamically acquired data and using the block 340, probabilities Pp_{CONT}^{int}(Zᵢ, tⱼ) 341, called “intermediate” probabilities, of airplane adhesion level.

Lastly it comprises merging 394, using the block 350, these various probabilities Pc_{CONT}^{int}(Zᵢ, tⱼ), Pp_{CONT}^{int}(Zᵢ, tⱼ) and P_{μ}^{int}(Zᵢ, tⱼ) to obtain the pavement state Edef(Zi), Ej(Zi).

In step 383, this determined state is exploited in the form of a notice 398 or of an input of an avionics system 399.

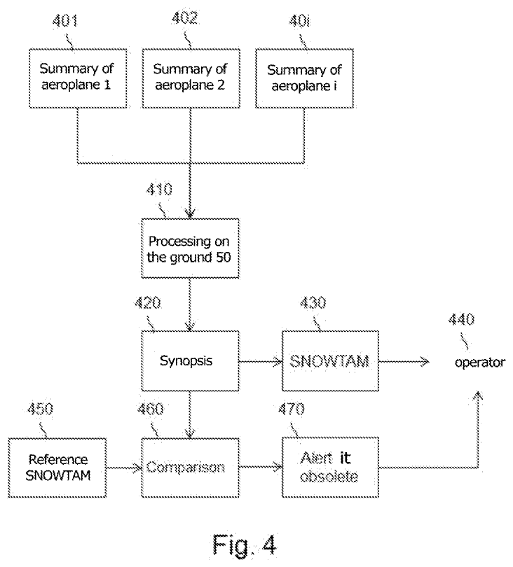

FIG. 4 schematically illustrates processing, by the ground station 50, of the final pavement states Edef(Zi), Ej(Zi) returned by a plurality of airplanes for the same pavement.

The summary notices 401, 402, 403, here delivered by 3 airplanes, comprise the final pavement states, which are generally computed for a plurality of zones of the pavement (which zones may be different for the 3 airplanes).

In one embodiment, these summary notices comprise a single pavement state per zone: preferably, the final pavement state Edef(Zi) computed from the dynamic data, when it exists (if the airplane has taxied over this zone Zi), otherwise the latest upstream pavement state Ej(Zi) or an average Eavg(Zi) of the upstream pavement states computed for this zone Zi: Eavg(Zi)=averagej{Ej(Zi)}. To this end, the pavement states Ej(Zi) may be transposed to a numerical runway-condition-code scale (the runway condition code being the code associated with the various consecutive pavement states assigned the values 1, 2, 3, 4, etc.) in which case an average may be computed. The average may, for example, be computed from the various pavement states obtained at sufficiently closely spaced times; for example, an average may be computed of the pavement states obtained for the same zone in the last 5 seconds.

These notices are processed in the block 410 by the ground station 50 so as to generate a synopsis 420 representative of the conditions of contamination of the pavement.

The block 430 then, for example, generates a SNOWTAM notice that is sent to an operator of the airplane 440 or out to airlines. In parallel or as a variant, the synopsis 420 may be compared to a SNOWTAM in force 450. This comparison 460 leads to the generation 470 of an alert in case of a SNOWTAM that is deemed obsolete or erroneous on account of the performed synopsis 420. The alert is then transmitted to the operator of the airport 440 or out to airlines, optionally accompanied by an updated SNOWTAM.

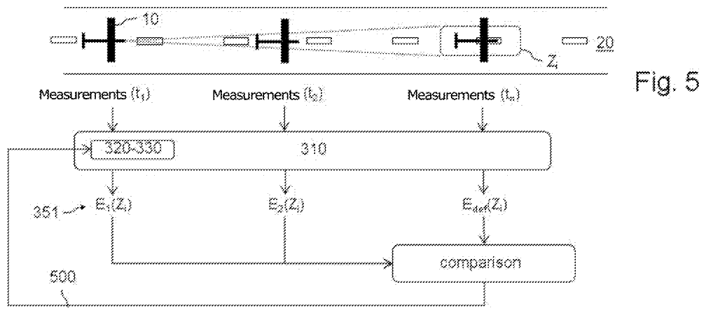

FIG. 5 schematically illustrates the determination of a pavement state Ej(Zi) at various times tj for a given pavement zone Zi.

Specifically, the landing airplane may determine, at the time t1, a pavement state E1(Zi) for this zone Zi, using the above mechanisms to determine a pavement state upstream of the airplane. Blocks 320 and 330 are employed, contrary to block 340.

Likewise, at the time t2 an upstream pavement state E2(Zi) is again determined for this zone Zi, using blocks 320, 330 and 350.

Other upstream pavement states Ej(Zi) may thus be determined while the airplane has not yet reached the zone Zi.

When the airplane is taxiing over the zone Zi, intermediate probabilities P_{μ}^{int}(Zᵢ, tⱼ) of adhesion level 341 may be obtained for this zone Zi using the block 340. They are then taken into account by the block 350 in order to emit a definitive pavement state Edef(Zi).

The system may then identify the bias (difference) between this definitive pavement state Edef(Zi) and each of the upstream pavement states Ej(Zi).

This bias may be sent to the ground station for processing.

This bias may, for example, be used in a feedback loop (arrow 500) to modify the block 310 for the sake of improving the upstream state determinations. Preferably, it is the ground station that compiles the biases returned by a plurality of airplanes in order to modify the block 310 (modification that will then be propagated to the airplanes).

For example, the weighting coefficients Pk used in block 320 may be adjusted. Furthermore, the use of the probabilities 311 by the block 350 (for example the step size of incrementation of the probabilities, the thresholds at which the modifications are triggered, etc.) may be adjusted.

Preferably, a neural network is used in a learning mode to, from this difference, adjust various variables used by the block 310, 320 and 350.

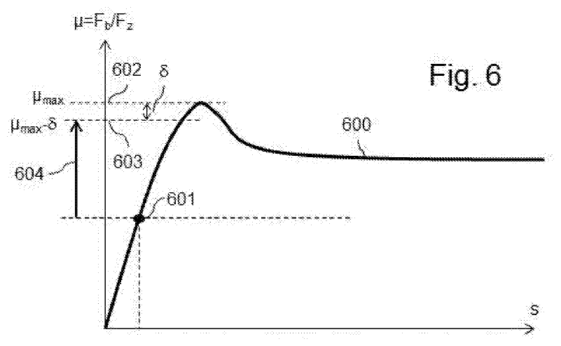

FIG. 6 illustrates a use of the final pavement state and of the adhesion-level probabilities P_{μ}^{int}(Zᵢ, tⱼ) 341 generated by the block 340 for a given zone Zi in combination with an evaluation of the slip ratio (ratio s). The use illustrated in the figure aims to determine the potential adhesion available to, for example, act on the braking of the airplane (for example by increasing it) so as to decrease the time spent taxiing on the pavement.

The available potential adhesion is determined using a model stored in memory (curve in the figure) and that is dependent on the determined pavement state.

The adhesion level μ of the airplane may be that corresponding to the highest probability among the probabilities P_{μ}^{int} (Zᵢ, tⱼ). By way of illustration, the adhesion level μ of the figure is that computed using the method described in patent application FR2978736: μ=Fb/FZ where

Fb is the braking force (for example evaluated at each wheel) and for example computed using: Fb=T/Rr where T is the torque applied by the braking system and Rr is the dynamic taxiing radius of the wheel, and

FZ is the vertical load applied to the wheels of the airplane, as measured by the sensor 126 for example.

The slip ratio s is determined, in patent application FR2978736, by s=(Vx−Vc)/Vx where Vx is the ground speed of the airplane (as measured using the GPS/IRS/experimenter 120 for example and Vc is the linear speed of the wheel (measured using the revolution counter 121 for example). Of course, other methods may be employed.

The pavement state computed by the block 310 for the current taxiing zone of the airplane is used to determine the model 600 of curve μ=f(s), one example of which is shown in the figure. Specifically, the curve differs depending on the pavement state.

The current operating point 601 illustrates the current pair (μ,s) of the airplane or the closest point on the curve.

The maximum theoretical value μmax, 602, of μ is determined. Optionally a margin δ is taken into account, thus defining a maximum operating value 603 (μmax−δ).

The available potential adhesion 604 is thus computed to be the difference between this maximum operating value 603 and the current μ.

This information is, in particular, used by the anti-skid system to automatically improve the braking of the airplane. Specifically, the anti-skid system may increase the braking force to the extent allowed by the available potential adhesion 604, i.e., provided that μ does not exceed μmax−δ.

It is also possible to use the ratio ‘s’ obtained by 330 to determine whether there remains any slip in reserve (difference between's′ and the optimum ratio corresponding to the peak, optionally decreased by margin) in order optionally to further control braking, if necessary.

The determination of a pavement stat Ej(Zi), Edef(Zi) e and its use according to the teachings of the invention have certain advantages.

It provides an extensive spatial vision of the pavement conditions, by virtue of the upstream determination of the pavement conditions on the basis of the acquired pavement data.

In particular, air-traffic control (control tower, for example) and the crew will have a better knowledge of pavement conditions and of their variation over time to the benefit, in particular, of airplane safety.

Specifically, this better knowledge allows the risks of pavement excursion to be decreased by adjusting braking or by making better strategic taxiing choices (choice of an exit taxiway).

Moreover, the invention allows the pavement to be continuously monitored by airplanes. Thus, better strategic choices as to the management of the pavement may be made. For example, long in situ inspections of the pavement may be carried out less frequently, improving the availability of the pavement for airport operations. The overall capacity of the airport, and the punctuality of airplanes and the predictability of operations, is thus improved thereby.

Furthermore, this continuous monitoring improves the reactiveness of support teams with respect to interventions on the pavement (spray of antifreeze, for example) and also allows the amount of products to be applied to precise zones of the pavement to be optimized. The impact of these products on the natural environment is thus decreased.

The use of a plurality of sensor-based methods (the sensors employed by these methods sometimes being different) to determine contaminant probabilities makes it possible to achieve a high system robustness to failure of one or more sensors, but also a higher confidence in the results (since the measurements of one sensor are, eventually, compared with other measurements) and an enhanced spatial precision.

By way of illustration, known techniques, for example, allow a MEDIUM to POOR (level 2) braking (or adhesion) level to be determined for a pavement segment of 200 m. The level of confidence in this determination is, however, low because of the small length considered in the evaluation. It is, for example, a question of a puddle of water in a thickness larger than 3 mm. This low confidence level means that this evaluation cannot be used by the airport.

Implementation of the invention using pavement data measured by on-board sensors allows the level of confidence in and the precision of the detected information to be increased. For example, by combining recognition in images, taken by cameras, of the presence of water of more than 3 mm thickness over 600-800 m of pavement with the detection of operating windscreen wipers, the measurement of a high humidity level, the detection of water spray behind the landing gear, the detection of a difference in slip between a plurality of wheels (indicating entry into a non-uniform contaminant), it is possible to determine that the pavement state is “WATER ABOVE 3 mm” with a high confidence level.

The preceding examples are merely embodiments of the invention, which is not limited thereto.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method comprising:
determining a pavement state from climatic data, and pavement data,
acquiring the climatic data and the pavement data by sensors located on-board an aircraft.

2. The method according to claim 1, wherein the climatic data comprises data on a climate outside of the aircraft operating on a pavement for aircraft.

3. The method according to claim 1, wherein the pavement data comprises data relating to a pavement on which the aircraft is operating.

4. The method according to claim 1, including the step of
determining the pavement state from dynamic aircraft operating data acquired by the sensors located on-board the aircraft.

5. The method according to claim 1, wherein the step of determining the pavement state is determined for a pavement segment upstream of the aircraft.

6. The method according to claim 1, including the steps of
obtaining at least one probability of presence of a type of contaminant for a location on a pavement, from the acquired pavement data, and
adjusting the probability of presence of the type of contaminant depending on probabilities of presence associated with respective types of pavement contaminants, the at least one probability being obtained, for the location on the pavement, from the acquired climatic data.

7. The method according to claim 6, wherein the probability of presence of the type of contaminant is furthermore obtained from taxiing information relative to a braking or adhesion level of the aircraft, the information being obtained from dynamic aircraft operating data acquired by sensors located on-board the aircraft.

8. The method according to claim 6, wherein a plurality of elementary probabilities of presence of the type of contaminant are obtained, using a plurality of respective obtaining methods, from the acquired pavement data, and an intermediate probability of presence of the type of contaminant is obtained via a weighted combination of the elementary probabilities.

9. The method according to claim 7, wherein a plurality of elementary probabilities relative to a braking or adhesion level of the aircraft are obtained, using a plurality of respective obtaining methods, from the acquired dynamic data, and an intermediate probability relative to an adhesion or braking level is obtained via a weighted combination of the elementary probabilities relative to a braking or adhesion level.

10. The method according to claim 8, wherein weighting weights in the weighted combination are dependent on an operational phase of the aircraft.

11. The method according to claim 1, wherein probabilities of presence of a type of contaminant are obtained for two or more locations in a given width of pavement.

12. The method according to claim 1, wherein an upstream pavement state is determined, from acquired climatic data and acquired pavement data, for a location that precedes the aircraft on a pavement.

13. The method according to claim 12, wherein the upstream pavement state is compared to a reference pavement state for said location.

14. The method according to claim 12, wherein the upstream pavement state is compared to a pavement state determined from climatic, dynamic and pavement data acquired for a common location.

15. The method according to claim 1, wherein the pavement data are acquired by at least one among a camera and a laser sensor located on-board the aircraft.

16. A system for determining a pavement state, comprising:
sensors located on-board an aircraft operating on a pavement for aircraft, and
a module configured to obtain a state of the pavement from climatic data, and pavement data, these data being acquired by the sensors located on-board the aircraft.

17. The system according to claim 16, wherein the climatic data comprises data on a climate outside the aircraft.

18. The system according to claim 16, wherein the pavement data comprises data relating to the pavement.

19. An aircraft comprising a system for determining a pavement state according to claim 16.
